(19) United States
(12) Patent Application Publication
(10) Pub. No.: US 2012/0085795 A1
(43) Pub. Date: Apr. 12, 2012

(54) ASSISTANCE DEVICE FOR MOVING PATIENTS

(76) Inventor: KUAN-TSUNG PENG, Taichung City (TW)

(21) Appl. No.: 12/903,159

(22) Filed: Oct. 12, 2010

(51) Int. Cl. A61G 1/00

(52) U.S. Cl. 224/159

(57) ABSTRACT

An assistance device for removing a patient only by one assistant and includes an enclosed main part which is mounted on one shoulder of the assistant and supports the patient's body between thigh and hip. A fastening member is movably connected to the main part and has an adjustment device which adjustably encloses the fastening member to fasten to the patient's leg. An assistance member is connected to the main part and a holding portion is connected to a distal end of the assistance member. The assistant holds the hold portion and support the weight of the patient by the main part to move the patient.

### FIELD OF THE INVENTION

The present invention relates to an assistance device, and more particularly, to an assistance device for moving a patient.

### BACKGROUND OF THE INVENTION

There are many patients who are not able to stand up, use washroom and walk by themselves so that when the patient needs to stand up, use washroom and walk, an assistant is needed to assist the patient to do these actions. However, the assistant has limited ability to support the patient's weight so that when the assistant holds the patient and tries to lift the patient body, the assistant has to hold the patient's body as close to his/her body as possible. This makes both of the assistant and the patient feel uncomfortable.

In addition, because the assistant can only apply limit force, so that if the patient weight 60 to 100 kg, at least two assistants are needed to move the patient from one place to another. This cannot be done by only one assistant so that the cost for taking care of the patients is high.

A large mechanical device can be used to move the patient from one place to another, but this requires sufficient room for the mechanical device and significant cost. Most of the families of the patients cannot afford it.

The present invention intends to provide an assistance device that is operated by one assistant and can lift the patient and move the patient from one place to another.

### SUMMARY OF THE INVENTION

The present invention relates to an assistance device for removing a patient only by one assistant and includes an enclosed main part which is mounted on one shoulder of the assistant and supports the patient's body between thigh and hip. A fastening member is movably connected to the main part and has an adjustment device which adjustably encloses the fastening member to fasten to the patient's leg. An assistance member is connected to the main part and a holding portion is connected to a distal end of the assistance member. The assistant holds the hold portion and support the weight of the patient by the main part to move the patient.

The primary object of the present invention is to provide an assistance device which is designed to be operated by only one assistant to move a patient from one place to another.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the assistance device of the present invention;

FIG. 2 is a side cross sectional view of the assistance device of the present invention;

FIG. 3 shows the operative status of the assistance device of the present invention, and

FIG. 4 shows another operative status of the assistance device of the present invention.

### DETAILED DESCRIPTION OF THE PREFERRED EMBODIMENT

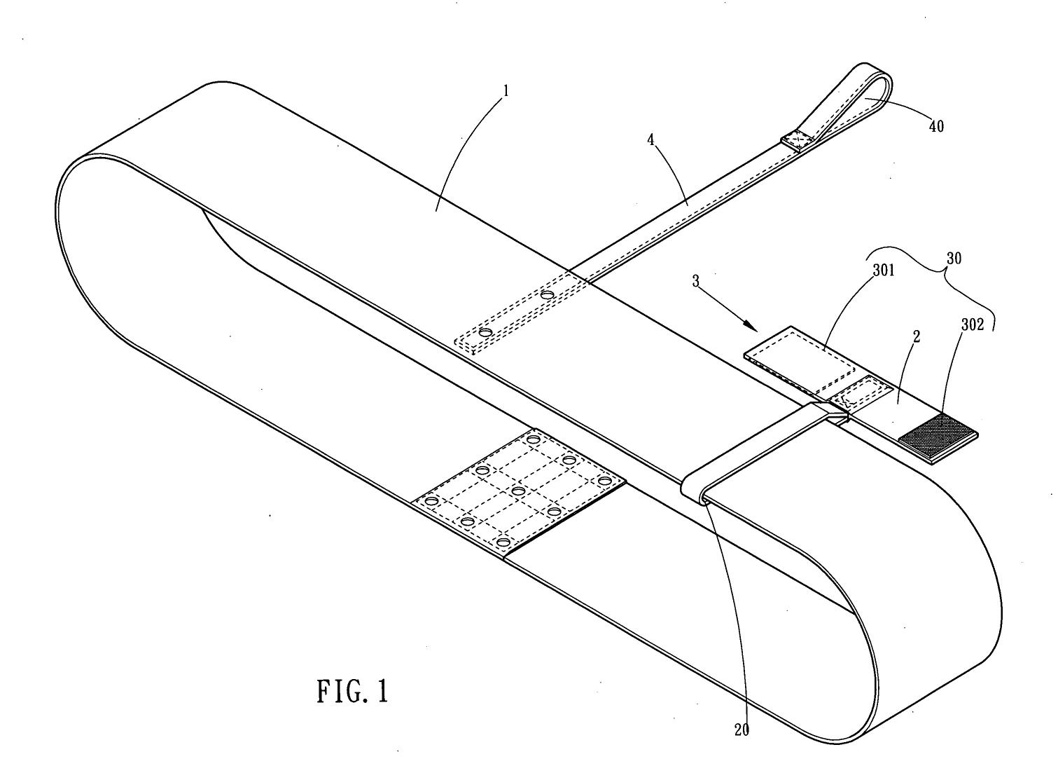

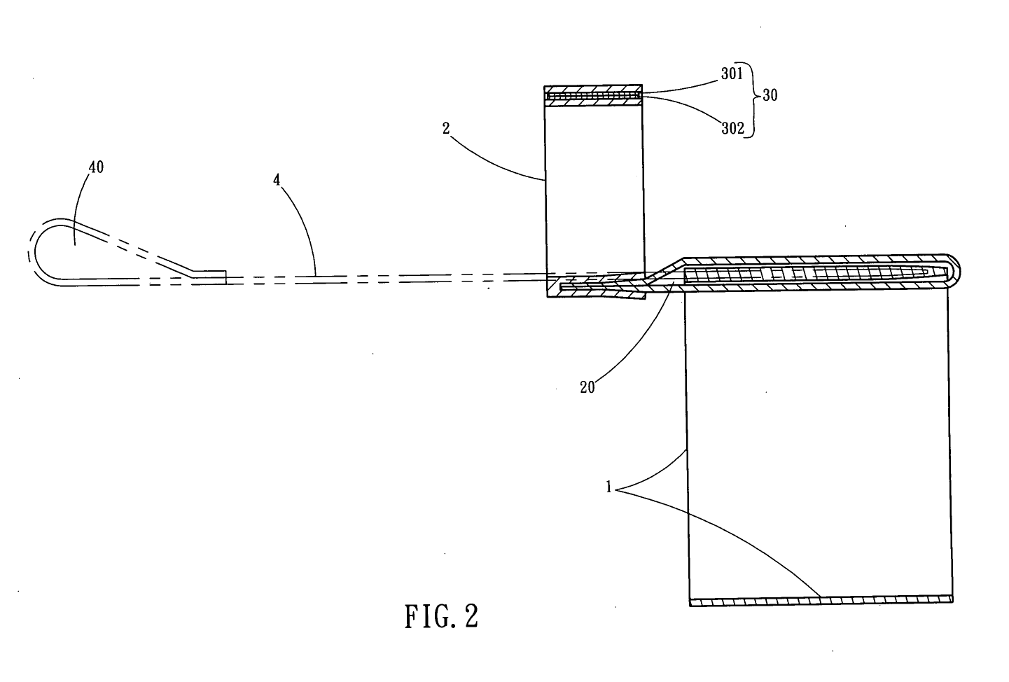

Referring to FIGS. 1 to 4, the assistance device of the present invention comprises an enclosed main part 1 which is made of flexible and durably material such as fabric, Nylon or Carbon-fibers. The assistant's body extends through the main part 1 and a portion of the main part 1 is put on one shoulder of the assistant, and the patient's body between thigh 503 and hip 51 is supported by the main part 1. The main part 1 can be formed by fixedly connecting two ends thereof by way of sewing. Alternatively, the main part 1 includes positioning pins and holes respective on the two ends thereof, the two ends of the main part 1 are adjustably connected to each other by connecting pins to holes at different positions.

A fastening member 2 has an enclosed passage 20 and the main part 1 extending through the passage 20 so that the fastening member 2 is movable along the main part 1. An adjustment device 3 is connected to two ends of the fastening member 2 and adjustably connects the two ends of the fastening member 2. The connected two ends of the fastening member 2 form an enclosed loop so that the patient's leg 5 can be fastened by the fastening member 2.

The adjustment device 3 on the fastening member 2 is a loop-hook unit 30 and includes a first portion 301 and a second portion 302 which is connected to the first portion 301. The first and second portions 301, 302 can be two Velcro strips. The adjustment device 3 can also be ropes which are tied to form the enclosed loop.

An assistance member 4 is connected to the main part 1 and a holding portion 40 is connected to a distal end of the assistance member 4. The assistance member 4 can be fixedly connected to the main part 1 or movably connected to the main part 1. The holding portion 40 and the assistance member 4 can be two individual parts and are connected to each other by any known way. The holding portion 40 of the assistance member 4 is a loop so that the assistant can hold the holding portion 40 when operating the assistance device.

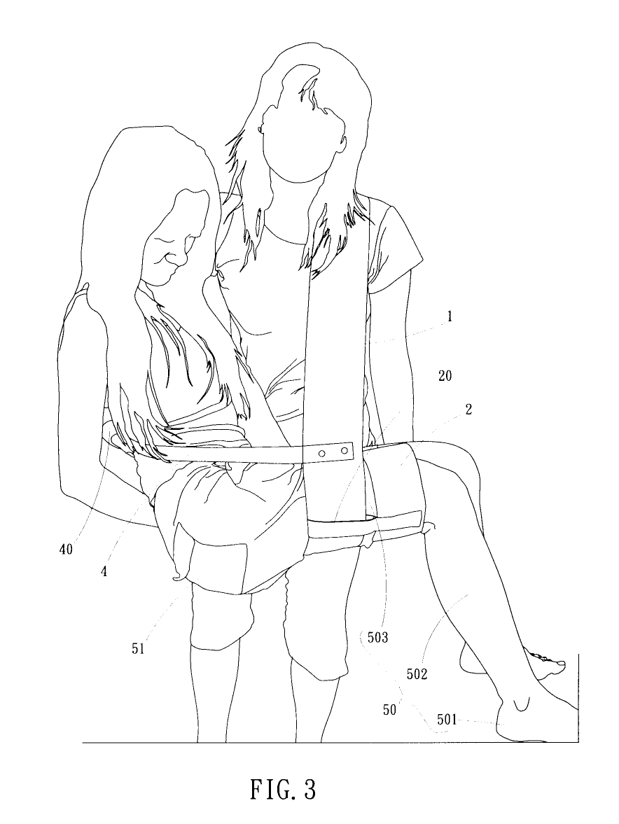

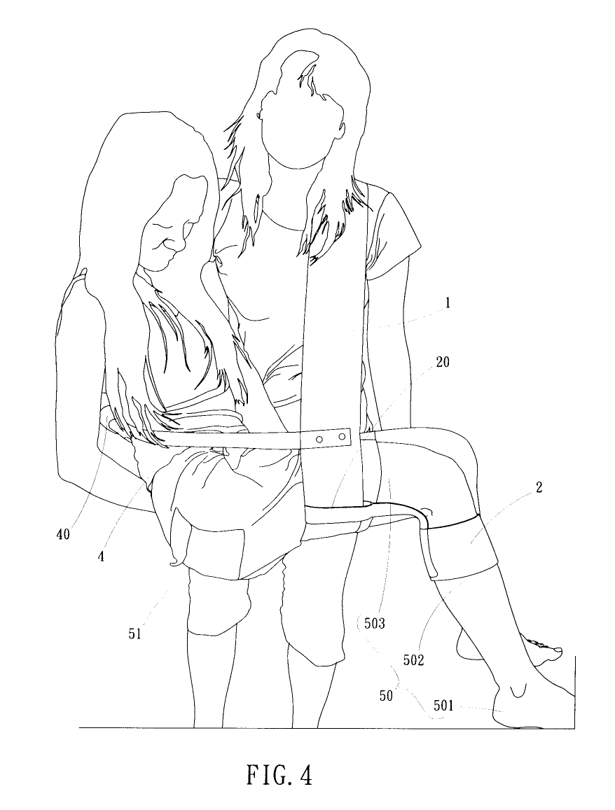

When in use, the patient's foot 501 is first located within the enclosed main part 1 and the main part 1 is moved along the leg 50 from the shin 502 to the portion between the thigh 503 and the hip 51. The fastening member 2 is then adjusted to the thigh 503 or the shin 502 and secures the fastening member 2 to the thigh 503 or the shin 502 by operation of the adjustment unit 3. The assistant uses his right hand to support the patient 5 at upright position and the left hand of the assistant holds the holding portion 40 and pulls the assistance member 4 around the back of the patient 5, and then let the assistant's right hand hold the holding portion 40. The assistant's body then inserts into the space between the main part 1 and the patient 5 until the main part 1 is put on the assistant's left shoulder as shown in FIGS. 3 and 4. When the assistant stands up, the patient is lifted by the assistance device of the present invention.

The assistance device of the present invention has simple structure and is easily manufactured at low cost. There is only one assistant to operate the assistance device of the present invention to move a patient from one place to another. Both of the assistant and the patient feel comfortable and convenient.

While we have shown and described the embodiment in accordance with the present invention, it should be clear to those skilled in the art that further embodiments may be made without departing from the scope of the present invention.

What is claimed is:

1. An assistance device comprising:
a main part being an enclosed member and adapted to support a patient's body between thigh and hip;
a fastening member having an enclosed passage and the main part extending through the passage so that the fastening member being movable along the main part;
an adjustment device connected to two ends of the fastening member and adjustably connecting the two ends of the fastening member, the connected two ends of the fastening member adapted to fasten to the patient's leg;
an assistance member connected to the main part and a holding portion connected to a distal end of the assistance member.

2. The device as claimed in claim 1, wherein the assistance member is fixedly connected to the main part.

3. The device as claimed in claim 1, wherein the assistance member is movably connected to the main part.

4. The device as claimed in claim 1, wherein the holding portion of the assistance member is a loop.

5. The device as claimed in claim 1, wherein the main part includes positioning pins and holes respective on two ends thereof, the two ends of the main part are adjustably connected to each other by connecting pins to holes at different positions.

6. The device as claimed in claim 1, wherein the adjustment device on the fastening member is a loop-hook unit and includes a first portion and a second portion which is connected to the first portion.
